(19) United States
(12) Patent Application Publication
(10) Pub. No.: US 2006/0201541 A1
(43) Pub. Date: Sep. 14, 2006

(54) Cleaning-drying apparatus and cleaning-drying method

(75) Inventors: Hideto Ohnuma, Atsugi (JP); Kazuya Hanaoka, Atsugi (JP); Kazuhiro Toshima, Atsugi (JP)

Correspondence Address: NIXON PEABODY, LLP, 401 9TH STREET, NW, SUITE 900, WASHINGTON, DC, 20004-2128, US

(73) Assignee: Semiconductor Energy Laboratory Co., Ltd., Atsugi-shi (JP)

(21) Appl. No.: 11/368,676

(22) Filed: Mar. 7, 2006

(30) Foreign Application Priority Data
Mar. 11, 2005 (JP) 2005-068473

(51) Int. Cl. B08B 3/02

(52) U.S. Cl. 134/148; 134/157; 134/902; 134/200

(57) ABSTRACT

It is an object to provide a semiconductor manufacturing apparatus provided with an apparatus performing a cleaning-drying process without a defect due to static electricity or the like, in a manufacturing process of a semiconductor device. One of features is that an ionizer included in a sheath is provided in a cleaning-drying apparatus. A structure in which an ionizer is covered with a sheath is used; accordingly, the ionizer can be operated without a concern of an electric leak due to an attachment of liquid. Also, static electricity generated in a cleaning-drying process can be removed.

### BACKGROUND OF THE INVENTION

1. Field of the Invention

The present invention relates to a cleaning-drying apparatus and a cleaning-drying method, and specifically, an apparatus for cleaning and drying a semiconductor element substrate.

2. Description of the Related Art

In the manufacture of a semiconductor device, a predetermined cleaning process and drying process are necessary after a wet etching process, a resist peeling process, and the like.

An apparatus for a cleaning process and a drying process during a manufacturing process of a semiconductor device has been developed. For example, in Patent Document 1, an apparatus is disclosed, in which a foreign substance or the like attached to a substrate surface is removed by supplying a cleaning liquid to a semiconductor element substrate, and the substrate is rotated and heated after a cleaning process to dry the substrate by the centrifugal force and heating. Also, in Patent Document 2, an apparatus is disclosed, in which a substrate is rotated after a cleaning process, and is dried by spraying gas for drying.

[Patent Document 1] Japanese Patent Laid-Open No. H06-216104

[Patent Document 2] Japanese Patent Laid-Open No. 2000-97564

However, when a semiconductor element substrate is processed by a cleaning-drying apparatus, defects by static electricity such as a destruction of a circuit and a characteristic deterioration are occurred due to a charge of the semiconductor element substrate and a rise of an electric potential due to a change in an electric capacitance which are occurred at the time of cleaning, drying and taking out the substrate from the apparatus, and accordingly, the yield is decreased. For example, in a case of a rotary cleaning-drying apparatus, a substrate is rotated at the time of a process. Accordingly, a defect is occurred with a charge of a semiconductor element substrate and a rise of an electric potential due to a change in an electric capacitance, by a friction between a cleaning liquid and a substrate at the time of a cleaning process, a friction between air in a chamber and the substrate at the time of a drying process, and a friction between a carrier and a carrier fixing jig when a carrier mounted with the substrate is taken out from a chamber, or the like.

Also, a conventional cleaning-drying apparatus has an ionizer, but does not have a structure in which an attachment of liquid or the like is considered. Therefore, when liquid or the like is dispersed and attached during an operation of an ionizer, an electric leak is occurred depending on the ionizer. Therefore, after a drying process is started, the drying process is performed for a certain period, and an operation period of the ionizer is adjusted so that the ionizer is operated only for a certain period after liquid is not attached to the ionizer.

### SUMMARY OF THE INVENTION

The present invention has been made in view of the foregoing problems. It is an object of the present invention to provide a semiconductor manufacturing apparatus in which a defect is not occurred in a manufacturing process of a semiconductor device. Specifically, it is an object of the present invention to provide a cleaning-drying apparatus which does not affect a processed substance (for example, a glass substrate, a semiconductor element substrate, and the like) in a cleaning-drying process.

A cleaning-drying apparatus of the present invention is an apparatus including a columnar chamber in which a cleaning-drying process of a processed substance is performed; a carrier mounting body provided inside the chamber to be able to rotate; a fixing jig for a carrier for a processed substance mounted with a processed substance, which is provided at the carrier mounting body (hereinafter, referred to as a carrier fixing jig in this specification); an ionizer provided outside the chamber to be close to the chamber; a sheath provided to be in contact with an outside surface of the chamber and also to include the ionizer; and an opening formed at a portion where the chamber and the sheath are in contact with each other.

Also, a cleaning-drying apparatus of the present invention is an apparatus including a columnar chamber in which a cleaning-drying process of a processed substance is performed; a carrier mounting body provided inside the chamber to be able to rotate in one direction; a carrier fixing jig provided at the carrier mounting body; an ionizer provided outside the chamber to be close to the chamber; a sheath provided to be in contact with an outside surface of an upper part of the chamber and also to include the ionizer; and an opening formed at a portion where the chamber and the sheath are in contact with each other, wherein the ionizer is provided at a position opposite to a rotation direction of the carrier mounting body with respect to the opening.

In the present invention, any ionizer is acceptable as long as it can generate ion and remove static electricity. Specifically, a corona discharge ionizer, a soft X-ray ionizer, and the like are given.

Further, in the present invention, the ionizer provided outside the chamber to be close to the chamber may be one or two or more. However, when ionizers are provided as much as possible, more ions can be generated, and accordingly, an ability to remove electricity is increased.

Also, a cleaning-drying apparatus of the present invention may include a processed substance sensing means provided inside the chamber, or a processed substance sensing means provided inside the chamber and also outside the chamber to be close to the chamber. As the processed substance sensing means, a sensor and the like, which can sense an existence of a processed substance or a carrier for a processed substance inside the chamber, may be used. By the processed substance sensing means, the presence or absence of the processed substance inside the chamber can be recognized.

Also, a sensing means may be provided at a door of a cleaning-drying apparatus instead of the processed substance sensing means so that opening and closing of the door is recognized. For example, a sensor may be provided at the door of the cleaning-drying apparatus so that the opening and closing of the door after a drying process can be sensed by the sensor and taking out the processed substance can be recognized.

Also, a cleaning-drying apparatus of the present invention may include one or two or more of a liquid supplying means provided inside the chamber, or one or two or more of a liquid supplying means provided inside the chamber and also outside the chamber to be close to the chamber. As liquid supplied from the liquid supplying means, a cleaning liquid, pure water, pure water added with CO₂, and the like may be used.

Also, a cleaning-drying apparatus of the present invention may include one or two or more of a gas supplying means provided inside the chamber, or one or two or more of a gas supplying means provided inside the chamber and also outside the chamber to be close to the chamber. As gas supplied from the gas supplying means, inert gas such as nitrogen or dried air may be used.

Furthermore, a cleaning-drying apparatus of the present invention may perform ionization to the gas supplied from the gas supplying means to discharge to the inside of the chamber. The cleaning-drying apparatus of the present invention dries a processed substance by using the centrifugal force by rotation; however, the cleaning-drying apparatus may spray gas or ion supplied from the gas supplying means to the processed substance, and may use it as purge gas for drying supplementarily.

Furthermore, the structure of the present invention provides a cleaning-drying method of a processed substance using a cleaning-drying apparatus including an ionizer, by which an ionizer is operated for a certain period after the termination of a drying process.

In the above structure of the present invention, a cleaning-drying method, by which a processed substance is taken out during an operation of an ionizer after the termination of a drying process, is provided.

The structure of the present invention provides a cleaning-drying method by which an ionizer is operated from a beginning of a cleaning process to the time when a processed substance is taken out after the termination of a drying process.

The structure of the present invention provides a cleaning-drying method by which an ionizer is operated from a beginning of a drying process to the time when a processed substance is taken out after the termination of the drying process.

The structure of the present invention provides a cleaning-drying method by which presence or absence of a processed substance inside a chamber is sensed by a processed substance sensing means provided inside the chamber, and an ionizer is operated during the period in which the existence of the processed -substance is sensed by the processed substance sensing means.

A cleaning-drying method, by which opening and closing of a door after the termination of a drying process is recognized by a sensing means provided at the door of a cleaning-drying apparatus, and an ionizer is operated until the door is opened and closed after the termination of the drying process, is provided.

By applying the above cleaning-drying method, an ionizer can be operated even when a carrier for a processed substance mounted with a processed substance is taken out from a cleaning-drying apparatus. Accordingly, static electricity generated due to a friction between the carrier for a processed substance and a carrier fixing jig can be removed, and also a rise of an electric potential due to a change in an electric capacitance can be suppressed, and a characteristic deterioration or the like due to static electricity of a processed substance can be prevented. However, it is not necessary to consider an electric leak or the like due to an attachment of water to an ionizer, as for a cleaning-drying method by which an ionizer is operated from a beginning of a drying process to the time when a processed substance is taken out after the termination of the drying process. Therefore, it is not limited to the cleaning-drying apparatus of the present invention, and can be applied to any cleaning-drying apparatus.

In the present invention, by generating ion by an ionizer and diffusing the generated ion inside a chamber from an opening, static electricity or the like generated by a friction between air inside the chamber and a processed substance and a contact of air inside the chamber with the processed substance or the like can be neutralized, and also a rise of an electric potential due to a change in an electric capacitance can be suppressed, and a characteristic deterioration or the like due to static electricity of a processed substance can be prevented. At this time, the number of ion which is enough to neutralize generated static electricity (electric charge) is necessary in order to prevent a charge of the processed substance effectively. In the present invention, since the ionizer is provided to be close to the chamber, a path to a diffusion of ion inside the chamber is short, and generated ion by the ionizer can be prevented from being neutralized by ion in the air in mid-flow. Accordingly, an ability to remove electricity is high, and a charge of the processed substance can be prevented effectively. In addition, the chamber can be prevented from being enlarged by providing the ionizer outside a columnar chamber, and electricity can be removed without disturbing an air current inside the chamber.

Also, since the ionizer is included in a sheath to be covered, a foreign substance, liquid, or the like can be prevented from attaching to the ionizer. Specifically, there is a concern that an electric leak due to an attachment of liquid is occurred as for an ionizer having an electrode, such as a corona discharge ionizer; therefore, a structure of the present invention which prevents an attachment of liquid or the like is extremely effective. In addition, in a case of providing the ionizer at a position which is upper than the opening and also opposite to a rotation direction of a carrier mounting body with respect to an opening formed at a portion where the chamber and the sheath are in contact with each other, further prevention of an attachment of liquid is possible. Also, by providing the sheath at an upper side than a rotation axis of the carrier mounting body, liquid can be prevented from accumulating inside the sheath, and liquid can be prevented from attaching to the ionizer provided inside the sheath. By using the structure of the present invention for a cleaning-drying apparatus, there is less concern of an electric leak of the ionizer, and the ionizer can be operated also during the cleaning process. Accordingly, static electricity generated by a contact of a cleaning liquid with the processed substance can be prevented. As described above, a defect resulted from static electricity of the processed substance is decreased, and a semiconductor device can be manufactured with high yield.

### BRIEF DESCRIPTION OF THE DRAWINGS

In the accompanying drawings:

FIGS. 1A to 1C are drawings explaining a cleaning-drying apparatus of the present invention;

FIGS. 2A and 2B are drawings explaining a cleaning-drying apparatus of the present invention;

FIGS. 3A to 3F are drawings explaining a soft X-ray ionizer.

FIGS. 4A to 4C are drawings explaining a cleaning-drying apparatus of the present invention; and

FIG. 5 is a drawing explaining a cleaning-drying apparatus of the present invention.

### DETAILED DESCRIPTION OF THE INVENTION

Hereinafter, embodiment modes of the present invention will be described in detail with reference to the accompanying drawings. However, the present invention is not limited to the description below, and it is easily understood by those skilled in the art that modes and details can be modified in various ways without departing from the spirit and the scope of the present invention. Therefore, the present invention should not be understood as being limited to the description of the embodiment modes to be given below. Note that in structures of the present invention described below, the reference numerals indicating the same are used in common in the drawings.

### Embodiment Mode 1

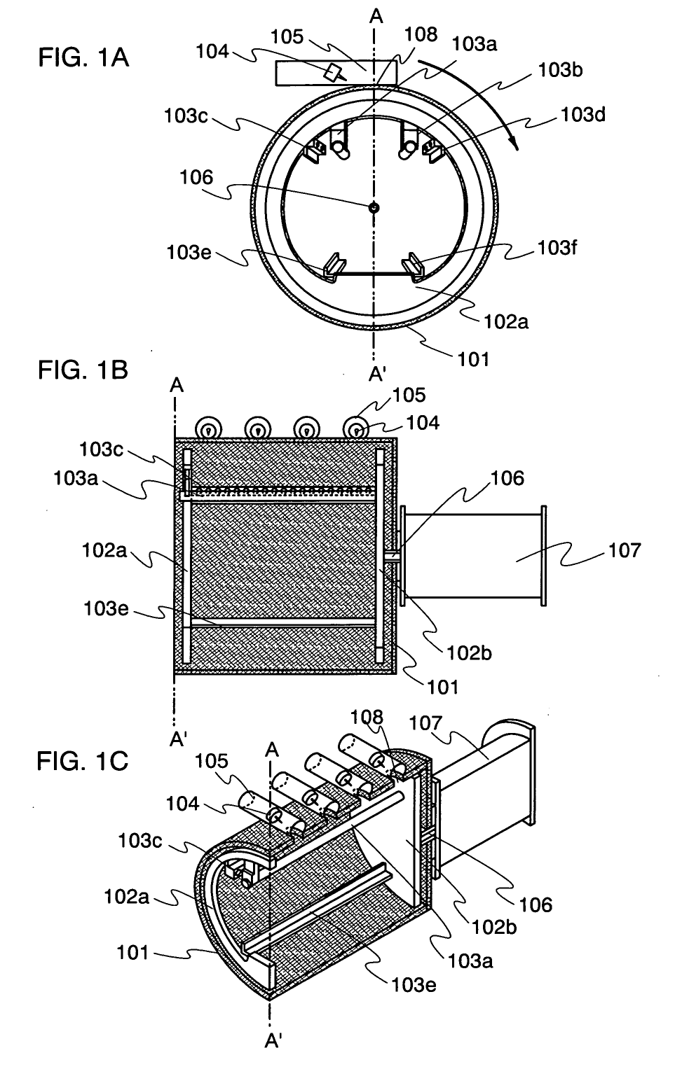

The present invention relates to a cleaning-drying apparatus for performing a predetermined cleaning-drying process in a manufacturing process of a semiconductor device. Hereinafter, the cleaning-drying apparatus will be described in detail with reference to FIGS. 1A to 1C.

FIG. 1A is a front view of the cleaning-drying apparatus of the present invention. FIG. 1B is a cross-sectional view in a depth direction to a paper surface, which is taken along a section line A-A′ of the cleaning-drying apparatus shown in FIG. 1A. FIG. 1C is a perspective view of FIG. 1B.

The cleaning-drying apparatus of the present invention includes a chamber 101; carrier mounting bodies 102a and 102b; carrier fixing jigs 103a, 103b, 103c, 103d, 103e, and 103f; an ionizer 104; and a sheath 105. The chamber 101 in which a cleaning-drying process is performed to a processed substance is columnar. The carrier mounting bodies 102a and 102b are provided inside the chamber 101. The carrier mounting bodies 102a and 102b are connected to a rotation axis 106 through a plane surface of the columnar chamber 101 (a top surface or a bottom surface of the columnar chamber), and further, is connected to a rotation means 107 such as a motor with the rotation axis 106 interposed therebetween. The carrier mounting bodies 102a and 102b are rotated around the rotation axis 106. Further, it is preferable that the carrier mounting bodies 102a and 102b rotate in one direction during a cleaning-drying process. In this embodiment mode, the carrier mounting bodies 102a and 102b during a cleaning-drying process rotate in one direction which is a direction indicated by a solid lined arrow in FIG. 1A.

Furthermore, the carrier mounting bodies 102a and 102b provided inside the chamber 101 are provided with the carrier fixing jigs 103a to 103f. A carrier for a processed substance mounted with a processed substance, which is held by the carrier fixing jigs 103a to 103f, is rotated with rotations of the carrier mounting bodies 102a and 102b inside the chamber 101, and accordingly, is dried by the centrifugal force. As the carrier fixing jigs 103a to 103f, a means by which the carrier for a processed substance mounted with a processed substance is held by the carrier mounting bodies 102a and 102b is preferable. In this embodiment mode, the carrier for a processed substance mounted with a processed substance is held by six carrier fixing jigs 103a to 103f provided at the carrier mounting bodies 102a and 102b.

Also, the carrier fixing jigs 103a to 103f may be movable. In FIGS. 1A to 1C, for example, the carrier fixing jigs 103a to 103d are movable, the carrier fixing jig 103c moves to the left, the carrier fixing jig 103d moves to the right, and the carrier fixing jigs 103a and 103b move upward, after a cleaning-drying process. Then, the carrier fixing jigs 103a to 103d are moved, and the carrier for a processed substance is held only by the carrier fixing jigs 103e and 103f. Accordingly, a charge of a substrate due to a friction between the carrier for a processed substance mounted with a processed substance and the carrier fixing jigs 103a to 103d, a rise of an electric potential due to a change in an electric capacitance, and the like can be suppressed. In this embodiment mode, four of six carrier fixing jigs 103a to 103f provided at the carrier mounting bodies 102a and 102b are movable; however, it is not limited thereto, and four or less or four or more of the carrier fixing jigs may be movable. In addition, since the carrier fixing jigs 103a to 103f may be a means which can fix the carrier for a processed substance mounted with a processed substance to the carrier mounting bodies 102a and 102b, a structure, in which six or less or six or more of carrier fixing jigs are provided, may also be used.

Furthermore, the ionizer 104 is provided outside the chamber 101 to be close to the chamber 101. A distance between the ionizer 104 and the chamber 101 may be a distance in which ion is diffused so that an ability to remove electricity inside the chamber 101 by the ionizer 104 can be maintained. However, when the distance between the ionizer 104 and the chamber 101 becomes longer, ion generated by the ionizer 104 is neutralized by ion and the like in the air in mid-flow, and the ability to remove electricity is decreased. Therefore, it is preferable that the ionizer 104 be provided as close as possible to the chamber 101. In this embodiment mode, four ionizers 104 are provided at positions opposite to a rotation direction of the carrier mounting bodies 102a and 102b indicated by an arrow in FIG. 1A, with respect to an opening 108 provided at the chamber 101. In other words, in a case where the carrier mounting bodies 102a and 102b are rotated in a clockwise direction (the direction of the arrow in FIG. 1A), a structure, in which an ionizer is provided on the left side of the opening 108 by seeing the opening 108 as the center, is used. Note that the number of the ionizer may be four or less, or four or more.

Furthermore, the sheath 105 is provided so that a part of the sheath is in contact with an outside surface of the chamber 101 and includes the ionizer. In this embodiment mode, the sheath 105 is provided so as to be in contact with the outside surface of the chamber 101, which is above the rotation axis 106 of the chamber 101. The opening 108 is formed at a portion where the chamber 101 and the sheath 105 are in contact with each other, and ion generated by the ionizer 104 inside the sheath 105 is diffused inside the chamber 101 through the opening 108. In the present invention, the sheath 105 means a scabbard, and plays a role as a cover which protects the ionizer 104 from a foreign substance, liquid, and the like. Specifically, the sheath may be formed from a glass; a metal; an insulating resin such as polypropylene, polyethylene, or polytetrafluoroethylene; and the like.

As in this embodiment mode, by providing the ionizer 104 inside the sheath 105, the ionizer 104 can be prevented from being attached by a foreign substance or liquid during a cleaning-drying process. Accordingly, there is no concern about an electric leak due to an attachment of a foreign substance or liquid to the ionizer 104, decrease of an ability to remove electricity, or the like. No concern about an electric leak enables the ionizer 104 to be operated during not only a drying process but also a cleaning process, and thus, it is extremely effective for preventing a charge of a processed substance.

Also, since the ionizer 104 and the sheath 105 are provided outside the chamber 101, the chamber is not necessary to be enlarged. Furthermore, an air current in the chamber is not disturbed, and accordingly, electricity can be removed effectively, and a charge of a processed substance can be prevented.

### Embodiment Mode 2

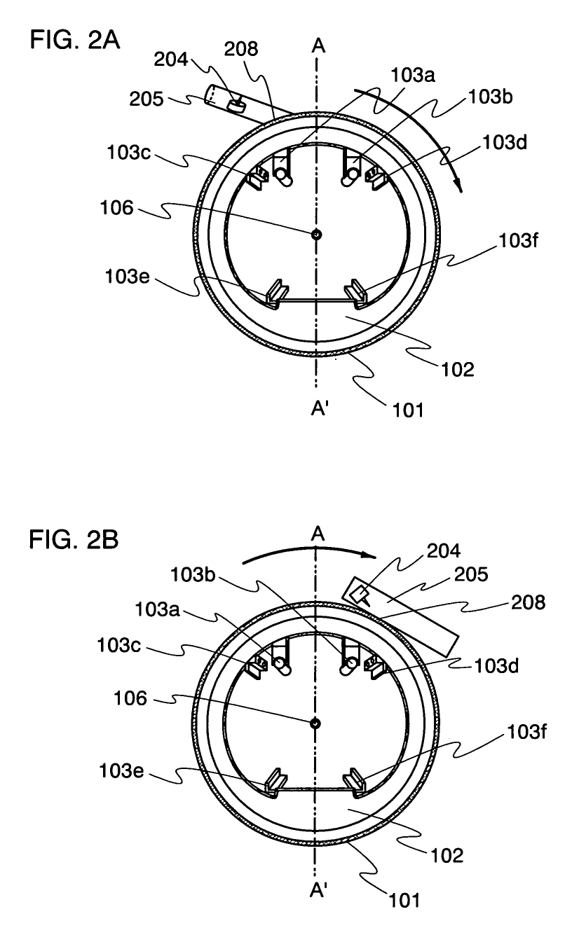

In this embodiment mode, a cleaning-drying apparatus in which positions of an ionizer and a sheath are different from Embodiment Mode 1 will be described with reference to FIGS. 2A and 2B.

In FIG. 2A, an ionizer 204 is provided at a position where it is harder for liquid to be attached than the position shown in FIGS. 1A to 1C. In FIGS. 1A to 1C, a structure, in which an efficiency of a removal of electricity is considered and the ionizer 104 is provided at a position where ion is diffused inside the chamber more easily, is described; however, in FIGS. 2A and 2B, a structure, in which preventions of an attachment of liquid and an electric leak are concerned, is used. Specifically, in a case of an ionizer having an electrode, the ionizer 204 is provided so that an electrode is provided at a position opposite to a rotation direction of the carrier mounting body with respect to an opening 208.

In FIG. 2B, a sheath 205 is provided so that a part of the sheath 205 is provided at a position lower than the opening 208. In this case, the ionizer 204 is provided at a position upper than the opening 208 so that liquid is not attached to the ionizer 204, and is also provided so as to be provided at a position opposite to a rotation direction of the carrier mounting body with respect to the opening 208. As shown in FIG. 2B, by providing a part of the sheath 205 to be lower than the opening 208, liquid can be removed even in a case where liquid is dispersed inside the sheath 205.

### Embodiment Mode 3

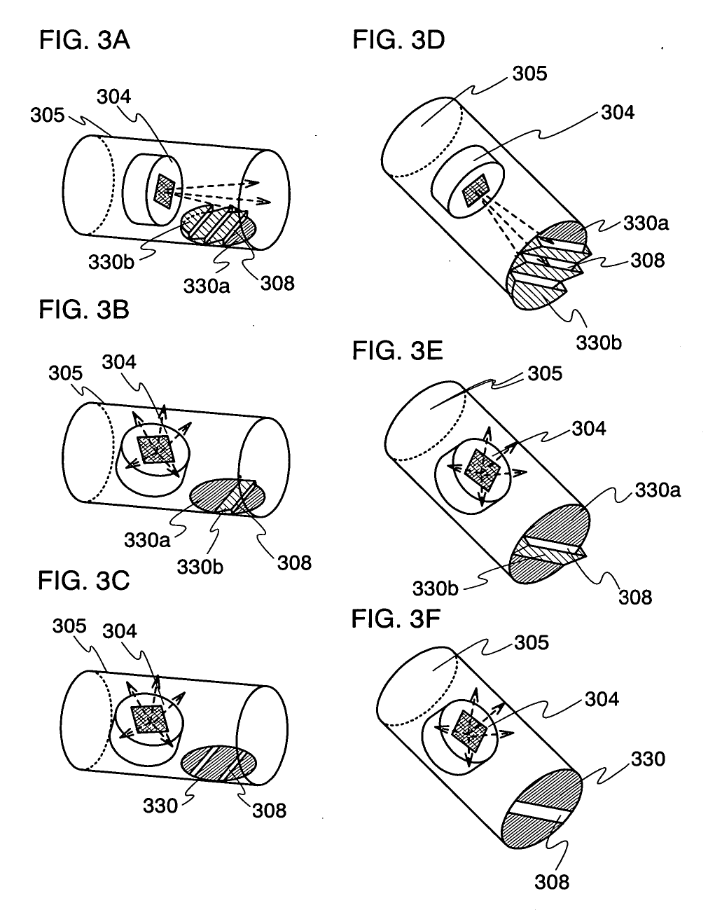

In this embodiment mode, a case where a soft X-ray ionizer is used as the ionizer in Embodiment Modes 1 and 2 will be described with reference to FIGS. 3A to 3F.

In a case of using a soft X-ray ionizer, it is necessary that surroundings and workers should not be irradiated with soft X-ray. In this embodiment mode, a structure, in which shielding plates 330, 330a and 330b are provided at an opening 308 formed at a portion where a sheath 305 and a chamber are in contact with each other, as shown in FIGS. 3A to 3F, is used. As the shielding plates 330, 330a and 330b, any shielding plate is acceptable as long as it can shield soft X-ray, and specifically, the shielding plates 330, 330a and 330b may be formed from polyvinyl chloride, aluminum, and the like.

In FIG. 3A, a case where the soft X-ray ionizer is applied to the ionizer of Embodiment Mode 1 is shown. In FIGS. 3A to 3F, dashed lined arrows show irradiation directions of soft X-ray of the soft X-ray ionizer. By providing shielding plates 330a and 330b to have difference in level at the opening 308, ion generated by a soft X-ray ionizer 304 is dispersed inside the chamber passing through a portion of the opening 308 which is not covered with the shielding plates 330a and 330b. Also, soft X-ray can be shielded by the shielding plates 330a and 330b.

Next, FIGS. 3B and 3C show a case where a soft X-ray ionizer 304 is provided so that the soft X-ray is emitted at a different angle from FIG. 3A. In FIG. 3B, shielding plates 330a and 330b are provided to have difference in level at an opening 308 in the same manner as FIG. 3A. Ion generated by the soft X-ray ionizer 304 is dispersed inside the chamber passing through a portion of the opening 308 which is not covered with the shielding plates 330a and 330b, and soft X-ray is shielded by the shielding plates 330a and 330b.

In FIG. 3C, a shielding plate 330 is provided so as not to cover an opening 308 completely. Ion generated by a soft X-ray ionizer 304 is dispersed inside a chamber passing through a portion of the opening 308 which is not covered with the shielding plate 330, and soft X-ray is shielded by the shielding plate 330. In order to disperse the ion generated by the soft X-ray ionizer inside the chamber effectively, an area of the opening 308 may be made large as long as the soft X-ray is not leaked.

In FIGS. 3D to 3F, a case where a soft X-ray ionizer is applied to the ionizer in FIG. 2A is shown. Note that relations among a soft X-ray ionizer 304, an opening 308, and shielding plates 330, 330a and 330b are the same as in FIGS. 3A to 3C.

In this embodiment mode, a structure in which the shielding plates 330, 330a and 330b which shield soft X-ray are provided at the opening 308 is described. Note that the present invention is not limited to this, and a structure, in which the soft X-ray is not leaked in the surrounding area and workers are not irradiated with the soft X-ray, may be used.

### Embodiment Mode 4

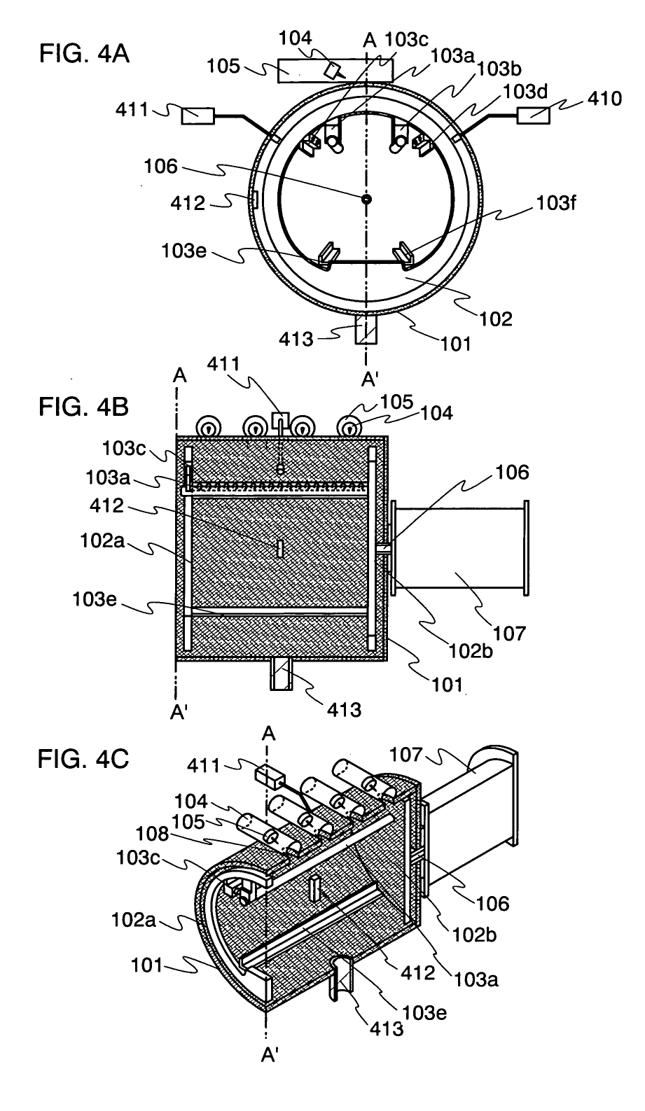

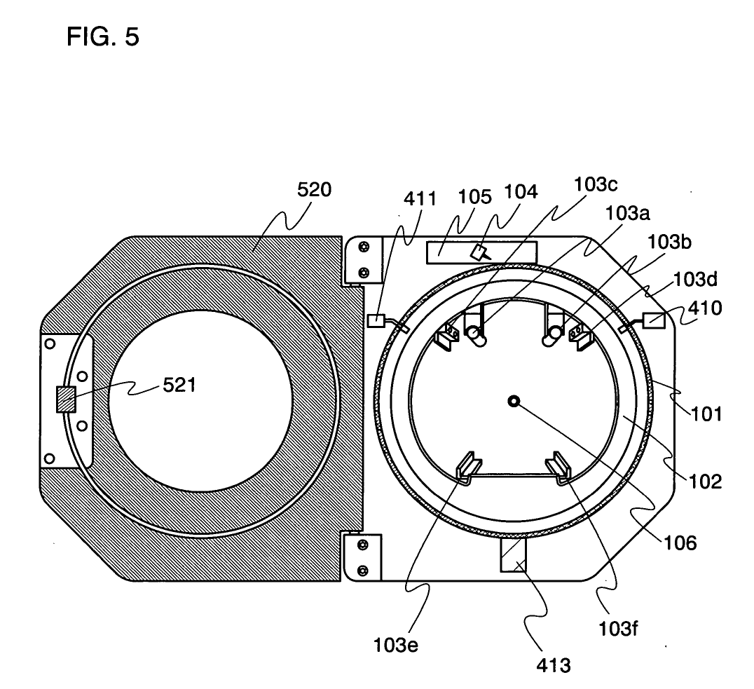

In this embodiment mode, in addition to the structures of Embodiment Modes 1 to 3, a structure, in which a liquid supplying means 410, a gas supplying means 411, and a processed substance sensing means 412 are provided, is shown by using FIGS. 4A to 4C and FIG. 5.

A liquid supplying means which supplies liquid to the inside of a chamber 101 is provided to be inside the chamber 101 or close to the chamber 101. In this embodiment mode, a structure, in which a nozzle is provided on an upper right of an inner wall of the chamber 101, and liquid is supplied to the inside of the chamber 101 from the liquid supplying means 410 through the nozzle, is used. As the supplied liquid, a cleaning liquid, pure water and the like may be used. By spraying liquid supplied from the liquid supplying means 410 to a processed substance, a foreign substance and the like attached to a processed substance surface can be cleaned and removed. Note that a position where the liquid supplying means 410 is provided is not particularly limited, and the liquid supplying means 410 may be provided so that liquid can be supplied to the chamber 101.

In a case of using pure water at the time of a cleaning process, CO₂ may be added and resistance may be reduced. In a case of performing a cleaning process using pure water, since pure water has high resistance, there is a concern that a charge of a processed substance due to a friction between the processed substance and pure water becomes large. Therefore, by operating an ionizer 104 of the present invention and also using a cleaning liquid in which pure water is added with CO₂ and the resistance is reduced during the cleaning process, a charge of the processed substance can be further prevented.

Also, a liquid discharging means for discharging liquid is provided at the chamber 101. The liquid discharging means may be a means which can discharge liquid inside the chamber 101 to the outside. In this embodiment mode, a structure, in which a discharge port is provided at a lower portion of the chamber 101 as a discharging means 413 and liquid is discharged to the outside of the chamber 101, is used. Note that a position where the discharging means 413 is provided is not particularly limited, and the discharging means 413 may be provided so that liquid can be discharged to the outside of the chamber 101.

Next, a gas supplying means which supplies gas to the inside of the chamber 101 is provided to be inside the chamber 101 or close to the chamber 101. In this embodiment mode, a structure, in which a nozzle is provided on an upper left of an inner wall of the chamber 101, and gas is supplied to the inside of the chamber 101 from the gas supplying means 411 through the nozzle, is used. As the supplied gas, nitrogen, dried air, and the like may be used. A cleaning-drying apparatus of the present invention dries a processed substance by using the centrifugal force by rotation; however, a drying process may have a supplementary role by spraying gas supplied from the gas supplying means 411 to the processed substance. Note that a position where the gas supplying means 411 is provided is not particularly limited, and the gas supplying means 411 may be provided so that gas can be supplied to the chamber 101.

Also, the gas supplying means may be provided so that gas is supplied through a sheath 105. Since gas supplied from the gas supplying means is ionized by the ionizer 104 to be discharged to the inside of the chamber 101, electricity can be removed more effectively.

A processed substance sensing means is provided to be inside the chamber 101 or close to the chamber 101. In this embodiment mode, a structure, in which the processed substance sensing means 412 is provided at a midsection on the left side of an inner wall of the chamber 101, is used. As the processed substance sensing means 412, a means which can sense presence or absence of a processed substance inside the chamber 101 may be used, and specifically, a light sensor, a weight sensor, and the like are given. By providing the processed substance sensing means 412 as in this embodiment mode, the presence or absence of a processed substance inside the chamber 101 can be sensed. Consequently, the ionizer 104 can be operated and electricity can be removed while the processed substance sensing means 412 senses the existence of a processed substance inside the chamber 101. A weight sensor can be provided at a carrier fixing jig and the like. In this embodiment mode, sensing presence or absence of a processed substance by the processed substance sensing means 412 enables the ionizer 104 to be operated until the processed substance is taken out. Accordingly, static electricity generated due to a friction between a carrier for a processed substance and carrier fixing jigs 103a to 103f can be removed. Note that a position where the processed substance sensing means 412 is provided is not particularly limited, and the processed substance sensing means 412 may be provided so that the presence or absence of a processed substance inside the chamber 101 can be sensed.

A structure, in which a door 520 by which a processed substance is taken in and out from a cleaning-drying apparatus is provided with a sensor 521 instead of the processed substance sensing means 412, and the ionizer 104 is operated at the same time as the opening and closing of the door 520, is shown in FIG. 5. In this case, opening of the door 520 after the termination of a drying process, taking out a carrier for a processed substance mounted with a processed substance, and closing of the door 520 are sensed. Consequently, the ionizer 104 can be operated at the same time as the opening and closing of the door 520. Accordingly, static electricity generated due to a friction between the carrier for a processed substance and carrier fixing jigs 103a to 103f when the processed substance is taken out can be removed, and a charge of the processed substance can be prevented.

In this embodiment mode, a structure in which all three means, the liquid supplying means 410, the gas supplying means 411, and the processed substance sensing means 412, are provided is described. Note that the present invention is not limited to this, and a structure, in which any one of the means or two means is/are provided, may be used. In addition, a structure, in which one liquid supplying means 410, one gas supplying means 411, and one processed substance sensing means 412 are provided, is described in this embodiment mode; however, a structure, in which a plurality of liquid supplying means 410, a plurality of gas supplying means 411, and a plurality of processed substance sensing means 412 are provided, may also be used.

Also, the cleaning-drying apparatus which performs a cleaning process and a drying process is described in the above Embodiment Modes 1 to 4. Note that the present invention is not limited to the above structure, and it can be applied to a cleaning apparatus which performs only a cleaning process or a drying apparatus which performs only a drying process.

### Embodiment Mode 5

In this embodiment mode, an example, in which a surface potential of a processed substance in a case where a cleaning-drying process is performed to a glass substrate as a processed substance is measured, will be described. Table 1 shows measurement results of a surface potential in a case of operating an ionizer until the termination of a drying process and a surface potential in a case of operating an ionizer for a certain period after the termination of a drying process and taking out a carrier for a processed substance mounted with a glass substrate during an operation of the ionizer, for comparison.

TABLE 1
Surface potential (kv) of a glass substrate

| | substrate A | substrate B |
|---|---|---|
| time of setting substrate | 0.19 | 0.20 |
| after termination of drying process | −0.13 | −0.12 |
| after taking out substrate | −2.0 | −0.083 |

As for a substrate A, in a predetermined cleaning-drying process using a cleaning-drying apparatus, an ionizer is operated from a beginning of a drying process to the termination of the drying process, and a carrier for a processed substance mounted with a glass substrate is taken out from the apparatus after the termination of the process. On the other hand, as for a substrate B, an ionizer is operated for a certain period from a beginning of a drying process to the termination of the drying process, and a carrier for a processed substance mounted with a glass substrate is taken out from the apparatus during the operation of the ionizer. Table 1 shows measurement results of surface potentials of the substrates A and B at the time of mounting the substrates A and B on a carrier for a processed substance and setting them in the cleaning-drying apparatus, at the time of terminating the cleaning, and at the time of taking out from the cleaning-drying apparatus.

According to Table 1, there are few differences in the surface potentials between the substrate A and the substrate B at the time of setting the substrates in the cleaning-drying apparatus and at the time of terminating the drying process; however, it is known that the potential of only the substrate A after being taken out from the apparatus is drastically increased.

Here, relations among a potential, an area, and a distance are described below. Note that V denotes a potential; C, electric capacitance; Q, an electric charge; ε, dielectric constant; ε₀, vacuum dielectric constant; S, an area; and d, a distance.

$$\begin{matrix}V = \frac{Q}{C} & [ Formula 1 ] \\ C = \frac{ɛ {ɛ}_{0} S}{d} & [ Formula 2 ]\end{matrix}$$

According to the above formulas 1 and 2, the following formula is obtained.

$$V = \frac{Qd}{ɛ {ɛ}_{0} S} \qquad [ Formula 3 ]$$

According to the above formulas 1 to 3, when an electric charge contained in the glass substrate surface is denoted as Q, an effective area of the glass substrate is denoted as S, and an effective distance between the carrier for a processed substance mounted with the glass substrate and a carrier fixing jig is denoted as d, d becomes large at the time of taking out the substrate, and accordingly, a potential V of the substrate also becomes high. Further, when the potential becomes high, static electricity discharge is generated, and a semiconductor element or the like is destroyed.

In the present invention, by taking out a substrate during an operation of an ionizer, a charge of the substrate due to a friction between a carrier for a processed substance mounted with a processed substance (substrate) and a carrier fixing jig, a rise of a potential due to a change in an electric capacitance, and the like can be suppressed, and a characteristic deterioration and the like of the processed substance can be prevented. Therefore, it is known that the operation of the ionizer at the time of taking out the substrate is extremely effective.

This application is based on Japanese Patent Application serial no. 2005-068473 filed in Japan Patent Office on March 11 in 2005, the entire contents of which are hereby incorporated by reference.

What is claimed is:

1. A cleaning-drying apparatus comprising:
a chamber;
a carrier mounting body provided inside the chamber, the carrier mounting body being able to rotate;
a carrier fixing jig provided at the carrier mounting body;
a sheath provided outside the chamber; and
an ionizer provided in the sheath.

2. The cleaning-drying apparatus according to claim 1,
wherein the chamber comprises an opening.

3. The cleaning-drying apparatus according to claim 1, further comprising:
one of a liquid supplying means provided inside the chamber and a liquid supplying means provided outside the chamber.

4. The cleaning-drying apparatus according to claim 1, further comprising:
one of a gas supplying means provided inside the chamber and a gas supplying means provided outside the chamber.

5. The cleaning-drying apparatus according to claim 1, further comprising:
one of a processed substance sensing means provided inside the chamber and a processed substance sensing means provided outside the chamber.

6. The cleaning-drying apparatus according to claim 5,
wherein the processed substance is a semiconductor element substrate.

7. The cleaning-drying apparatus according to claim 1,
wherein the chamber is columnar.

8. A cleaning-drying apparatus comprising:
a chamber;
a carrier mounting body provided inside the chamber, the carrier mounting body being able to rotate;
a carrier fixing jig provided at the carrier mounting body;
a sheath provided outside and an upper part of the chamber; and
an ionizer provided in the sheath.

9. The cleaning-drying apparatus according to claim 8,
wherein the chamber comprises an opening, and
wherein the ionizer is provided at a position opposite to a rotation direction of the carrier mounting body with respect to the opening.

10. The cleaning-drying apparatus according to claim 8, further comprising:
one of a liquid supplying means provided inside the chamber and a liquid supplying means provided outside the chamber.

11. The cleaning-drying apparatus according to claim 8, further comprising:
one of a gas supplying means provided inside the chamber and a gas supplying means provided outside the chamber.

12. The cleaning-drying apparatus according to claim 8, further comprising:
one of a processed substance sensing means provided inside the chamber and a processed substance sensing means provided outside the chamber.

13. The cleaning-drying apparatus according to claim 12,
wherein the processed substance is a semiconductor element substrate.

14. The cleaning-drying apparatus according to claim 8,
wherein the chamber is columnar.

15. A cleaning-drying apparatus comprising:
a chamber;
a carrier mounting body provided inside the chamber, the carrier mounting body being able to rotate;
a movable carrier fixing jig provided at the carrier mounting body;
a sheath provided outside the chamber; and
an ionizer provided in the sheath.

16. The cleaning-drying apparatus according to claim 15,
wherein the chamber comprises an opening.

17. The cleaning-drying apparatus according to claim 15, further comprising:
one of a liquid supplying means provided inside the chamber and a liquid supplying means provided outside the chamber.

18. The cleaning-drying apparatus according to claim 15, further comprising:
one of a gas supplying means provided inside the chamber and a gas supplying means provided outside the chamber.

19. The cleaning-drying apparatus according to claim 15, further comprising:
one of a processed substance sensing means provided inside the chamber and a processed substance sensing means provided outside the chamber.

20. The cleaning-drying apparatus according to claim 19,
wherein the processed substance is a semiconductor element substrate.

21. The cleaning-drying apparatus according to claim 15,
wherein the chamber is columnar.

22. A cleaning-drying apparatus comprising:
a chamber;
a carrier mounting body provided inside the chamber, the carrier mounting body being able to rotate;
a movable carrier fixing jig provided at the carrier mounting body;
a sheath provided outside and an upper part of the chamber; and
an ionizer provided in the sheath.

23. The cleaning-drying apparatus according to claim 22,
wherein the chamber comprises an opening, and
wherein the ionizer is provided at a position opposite to a rotation direction of the carrier mounting body with respect to the opening.

24. The cleaning-drying apparatus according to claim 22, further comprising:
one of a liquid supplying means provided inside the chamber and a liquid supplying means provided outside the chamber.

25. The cleaning-drying apparatus according to claim 22, further comprising:
one of a gas supplying means provided inside the chamber and a gas supplying means provided outside the chamber.

26. The cleaning-drying apparatus according to claim 22, further comprising:
one of a processed substance sensing means provided inside the chamber and a processed substance sensing means provided outside the chamber.

27. The cleaning-drying apparatus according to claim 26,
wherein the processed substance is a semiconductor element substrate.

28. The cleaning-drying apparatus according to claim 22,
wherein the chamber is columnar.

29. A method for cleaning and drying a processed substance using a cleaning-drying apparatus having an ionizer, the method comprising:
operating the ionizer from a beginning of a cleaning process to taking out the processed substance after the termination of a drying process.

30. The cleaning-drying method according to claim 29, wherein the processed substance is a semiconductor element substrate.

31. A method for cleaning and drying a processed substance using a cleaning-drying apparatus having an ionizer, the method comprising:
operating the ionizer for a certain period, and
taking out the processed substance from the cleaning-drying apparatus during operating the ionizer.

32. The cleaning-drying method according to claim 31, wherein the processed substance is a semiconductor element substrate.

33. A method for cleaning and drying a processed substance using a cleaning-drying apparatus having an ionizer, the method comprising:
operating the ionizer from a beginning of a drying process to taking out of the processed substance after the termination of a drying process.

34. The cleaning-drying method according to claim 33, wherein the processed substance is a semiconductor element substrate.

35. A method for cleaning and drying a processed substance using a cleaning-drying apparatus having an ionizer, the method comprising:
sensing the processed substance by a processed substance sensing means provided inside the chamber, and
operating the ionizer while sensing the processed substance.

36. The cleaning-drying method according to claim 35, wherein the processed substance is a semiconductor element substrate.

37. A method for cleaning and drying a processed substance using a cleaning-drying apparatus having an ionizer, the method comprising:
recognizing opening and closing of a door after the termination of a drying process by a sensor provided at the door of the cleaning-drying apparatus, and
operating the ionizer until the door is opened and closed after the termination of a drying process.

38. The cleaning-drying method according to claim 37, wherein the processed substance is a semiconductor element substrate.
